(19) United States
(12) Patent Application Publication
(10) Pub. No.: US 2007/0039931 A1
(43) Pub. Date: Feb. 22, 2007

(54) Applicating assembly for weld material and method of applying weld material

(76) Inventors: Vancho Naumovski, Shelby Township, MI (US); Dragos Catanescu, Rochester Hills, MI (US)

Correspondence Address: Clark Hill PLC, Suite 3500, 500 Woodward Ave., Detroit, MI, 48226-3435, US

(21) Appl. No.: 11/205,489

(22) Filed: Aug. 17, 2005

(51) Int. Cl. B23K 26/20

(52) U.S. Cl. 219/121.64; 219/121.63

(57) ABSTRACT

A dispensing assembly dispenses a colloidal mixture onto a part at a weld position. The dispensing assembly includes a supply reservoir for holding the colloidal mixture therein. The dispensing assembly also includes an inline mixer in fluid communication with the supply reservoir for mixing the colloidal mixture received from the supply reservoir. A valve is in fluid communication with the inline mixer for dispensing the colloidal mixture at the weld position. A preliminary mixer is disposed within the supply reservoir for preliminarily mixing the colloidal mixture prior to transmission of the colloidal mixture to the inline mixture.

### BACKGROUND ART

1. Technical Field

The invention relates to an assembly used in the welding of metals together. More specifically, the invention relates to a dispensing assembly for applying materials at a weld position to facilitate the weld process.

2. Description of the Related Art

Welding is the process of using heat to join two components together. In some instances, pressure is used in the process. In other methods, a third material is used. The process of welding components together is a very effective process when assembling structures because the resulting union of the parts is as strong or stronger than it would have been using other means to fasten the parts together.

Another reason why parts are welded together as opposed to other means is due to the aesthetic result of welding. When finished, the parts joined together often look like a single part. This provides a look that is pleasing. In some instances, this enhanced look can also be useful in a functional sense. This is true when fluids flow past the joined parts and the finished composite part does not create turbulences or flow disruptions at the weld position.

When the parts being welded are galvanized steel, there is a potential for poor weld quality if the source of heat is elevated rapidly and concentrated in a specific area. This typically occurs when a laser or electron beam is used in the welding process to heat the metals. The poor welding results occur because a laser weld occurs rapidly and the vaporization of certain materials in the weld area are trapped within the molten material created by the laser beam. In these situations, the zinc material used in the galvanization of the metal has a lower melting point resulting the rapid vaporization of that metal while continued energy is being impinged upon the metal to melt the steel or iron.

U.S. Pat. No. 3,969,604 discloses a method for joining galvanized steel metal through a welding process wherein a flux material is deposited on the area in which the welding is to occur. This flux material is characterized by a melting temperature that is substantially the same or higher than the steel parts. When the flux material is placed in the weld location, a high energy density beam, e.g., a laser beam, impinges the area allowing the welding process to occur while preventing vapor created by the melting of the zinc to be trapped within the welding materials allowing for a smoother finish.

Currently, there is no system for accurately and effectively applying the flux material to the weld position. This causes for increased waste and finish parts that do not conform to tolerances and/or specifications.

### SUMMARY OF THE INVENTION

A dispensing assembly dispenses a colloidal mixture onto a part at a weld position. The dispensing assembly includes a supply reservoir for holding the colloidal mixture therein. The dispensing assembly also includes an inline mixer in fluid communication with the supply reservoir for mixing the colloidal mixture received from the supply reservoir. A valve is in fluid communication with the inline mixer for dispensing the colloidal mixture at the weld position. A preliminary mixer is disposed within the supply reservoir for preliminarily mixing the colloidal mixture prior to transmission of the colloidal mixture to the inline mixture.

### BRIEF DESCRIPTION OF THE DRAWINGS

Advantages of the invention will be readily appreciated as the same becomes better understood by reference to the following detailed description when considered in connection with the accompanying drawing, wherein:

FIG. 1 is a plan view of a first embodiment of the invention; and

FIG. 2 is a plan view of a second embodiment of the invention.

### DETAILED DESCRIPTION OF THE PREFERRED EMBODIMENT

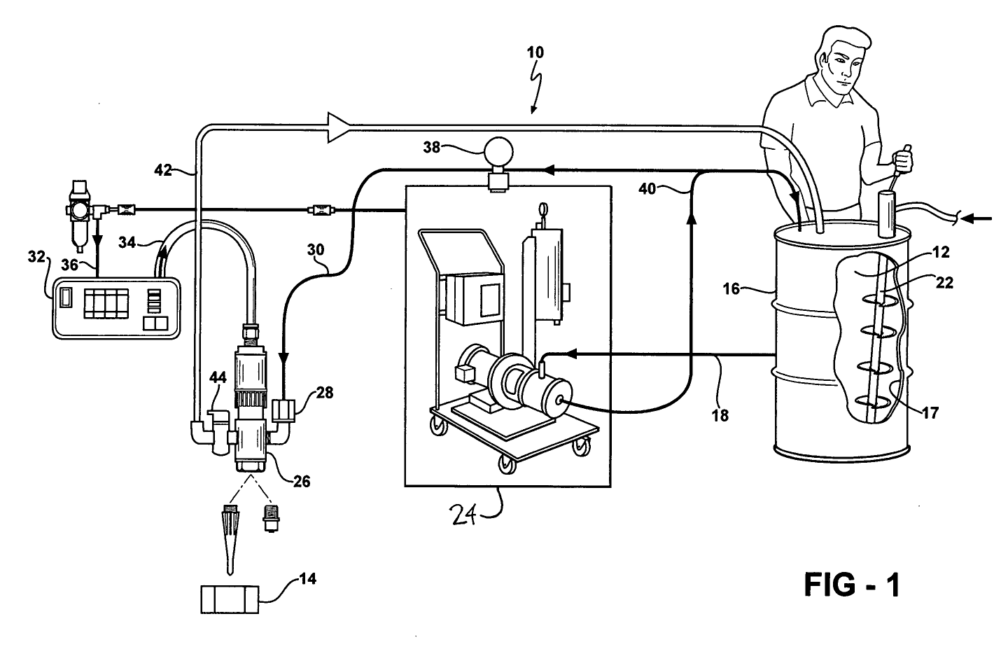

Referring to FIG. 1, a dispensing assembly is generally indicated at 10. The dispensing assembly is designed to dispense a colloidal mixture 12 onto a part 14 at a weld position. Typically, there are two parts 14 (one shown) that are to be welded together. The colloidal mixture 12 includes at least two components, the powdered metal suspended by an oil. The oil is used simply to control the powdered metal as the powdered metal is being applied to the weld position. Once there, the welding utilizes the metal powder and the oil remains inactive through the process. After the weld is completed, the oil is removed through a cleaning process. The metal powder used is one that has a melting point similar to the Zinc in the galvanized steel.

The colloidal mixture 12 is stored within a barrel 16 of such a quantity sufficient to perform enough of the welding procedure. In the embodiment shown, the barrel 16 is a 55 gallon (industrial size) drum. The barrel 16 defines a supply reservoir 17 for holding the colloidal mixture 12 therein in preparation for and during the dispensing thereof. The dispensing assembly 10 may include the opportunity to utilize a plurality of barrels 16 to facilitate the continuous operation of the dispensing assembly 10 by sequentially feeding colloidal mixture 12 from each of the barrels 16 in succession. In one embodiment, the dispensing assembly 10 would include a pair of barrels 16 which would be used to draw colloidal mixture 12 into the dispensing assembly 10 and the second would be made ready to be used upon the emptying of the first barrel. Then the first barrel can be switched out with a full barrel while operating the second barrel.

The dispensing assembly includes a gravity feed line 18 that is in fluid communication with the supply reservoir 17 disposed toward the bottom of the barrel 16. The barrel 16 has a preliminary mixer 20 disposed within the supply reservoir 17. The preliminary mixer 20 mixes the colloidal mixture 12 prior to the transmission of the colloidal mixture 12 through the gravity feed line 18. The preliminary mixer 20 in one embodiment is pneumatically driven and includes an auger 22 that extends down into the supply reservoir 17. The preliminary mixer 20 is a bung mount mixer allowing for pressure to be applied within the supply reservoir 17 should the gravity feed line 18 need assistance in moving the colloidal mixture 12 out through the gravity feed line 18.

The dispensing assembly 10 also includes an inline mixer 24. The inline mixer is in fluid communication with the supply reservoir 17. The inline mixer 24 mixes the colloidal mixture 12 received from the supply reservoir 17 prior to its dispensing at the weld position.

The colloidal mixture 12 is moved out from the inline mixer 24 and to the weld position where it is dispensed using a valve 26. The valve 26 is in fluid communication with the inline mixer 24 and dispenses the colloidal mixture at the weld position when the valve 26 is open. The valve 26 includes an inlet connection 28 to which a feed line 30 is connected allowing the colloidal mixture 12 to reach the valve 26. The valve 26 is controlled pneumatically by a controller 32 that supplies pulsed air through a control line 34. The controller 32 receives pressurized air through a supply air line 36.

The dispensing assembly also includes a pressure reducing valve 38. The pressure reducing valve 38 is in fluid communication between the valve 26 and the inline mixer 24. The pressure reducing valve 38 reduces the pressure of the colloidal mixture 12 upon its departure from the inline mixer 24 prior to its receipt by the valve 26. The inline mixer 24 forces the colloidal mixture out therefrom at a pressure in the range of approximately 60-100 psi. The pressure reducing valve 38 reduces the pressure of the colloidal mixture 12 for its receipt by the valve 26.

When the valve 26 is closed, a fluid re-circulation line 40 receives the colloidal mixture 12 that is dispensed from the inline mixer 24. The fluid re-circulation line 40 extends between the inline mixer and the barrel 16. To continue the circulation of the fluid to maintain the colloidal mixture in its optimum mixture state, the inline mixer 24 must continue the circulation process of the colloidal mixture 12.

Likewise, when the valve 26 is closed, the colloidal mixture 12 is removed from the feed line 30 and the valve 26 through an inline fluid re-circulation line 42. The inline fluid re-circulation line 42 extends between a bypass valve 44 which is mounted to the valve 26, and the barrel 16.

In operation, the method for dispensing a fine colloidal mixture to a weld position between first and second metal parts 14 includes the step of receiving a mixture of liquid and particles. The initial mixture of liquid of liquid and particles is a colloidal mixture 12 stored within the barrel 16. When inside the barrel 16, an initial mixing of the mixture of liquid and particles to create the colloidal mixture 12 is done by the preliminary mixer 12. The colloidal mixture is then fed to an inline mixer 24. The inline mixer 24 finely mixes the colloidal mixture to create the fine colloidal mixture. Once the fine colloidal mixture is mixed and released from the inline mixer 24, the pressure applied to the fine colloidal mixture is reduced. The fine colloidal mixture is passed to the dispensing valve 26 and it is applied to the weld position prior to the welding of the first and second metal parts. If the dispensing valve 26 is not open, the mixture of liquid and particles is re-circulated. In addition, the fine colloidal mixture is also re-circulated to the barrel 16 when the dispensing valve is closed.

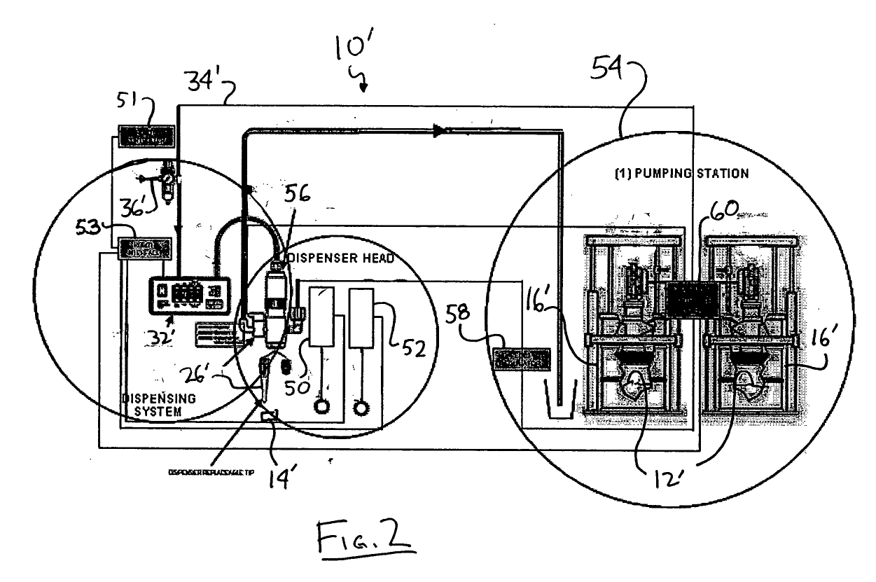

Referring to FIG. 2, wherein like primed reference characters represent similar elements as those described in the first embodiment of FIG. 1, a second embodiment of the dispensing assembly is generally indicated at 10′. The dispensing assembly 10′ is designed to dispense a colloidal mixture 12′ that is composed of a different mixture. The colloidal mixture 12′ includes a petrolatum base with metal spherules suspended therein. The colloidal mixture 12′ is described more fully in a co-pending patent application having U.S. application Ser. No. 11/180,793, filed on Jul. 13, 2005 of common inventorship and ownership, the disclosure of which is hereby incorporated herewith.

Because the colloidal mixture 12′ is a petrolatum base, several of the elements found in the first embodiment are not necessary. Principally, the preliminary mixer 20 and the inline mixer 24 are no longer needed because the colloidal mixture 12′ has a viscosity sufficient that it will maintain the metal spherules in suspension from the moment it is mixed until the time the dispensing assembly 10′ applies the colloidal mixture 12′ to the part to be welded.

One primary difference between the disclosure of the dispensing assembly 10 of the first embodiment and the dispensing assembly 10′ of the second embodiment is the valve 26′. Mounted to the valve 26′ are to sensors 50, 52. The first sensor 50 is designed to sense the presence of the part(s) 14′ to be welded. The second sensor 52 is designed to sense the presence of the bead of colloidal mixture 12′ being applied to the part 14′. In this embodiment, both sensors 50, 52 are laser sensors designed to precisely identify the location of their respective targets.

The feedback signal from the first sensor 50 is sent to the controller 32′ allowing the controller 32′ the initiate the dispensing of the colloidal mixture 12′. In addition, the first sensor 50 provides crash protection by identifying the part 14′ and having a robot arm (graphically represented at by a robot controller 51 and robot interface 53) which positions the valve 26′, inhibit the valve 26′ from impacting the part 14′. The feedback signal from the second sensor 52 ensures the colloidal mixture 12′ is evenly dispensed along what becomes the weld seam on the part 14′. If the bead of colloidal mixture 12′ is not present, the feedback signal from the second sensor 52 will indicate to the controller 32′ that the robot arm that positions the valve 26′ is not to be moved. Once a pumping station 54 pumps the colloidal mixture 12′ to the valve 26′, the second sensor 52 will indicate such and the robot arm will move the valve 26′ along the part 14′ at the weld seam. It should be appreciated by those skilled in the art that should the valve 26′ be designed for an application that does not need the valve 26′ to move, the first sensor 50 would not be used.

The pressure applied to the barrels 16′, shown in cross-over configuration for reduction and/or elimination of down time for replacement of barrels 16′ once one is empty, ensures that a constant pressure is applied to the colloidal mixture 12′. This ensures that sufficient amounts of colloidal mixture 12′ are fed through the feed line 30′ to the valve 26′ so that application of the colloidal mixture 12′ is uniform.

In operation, the controller 32′ pulses air at a specified pressure on a dispensing unit piston 56 to open the flow through the valve 26′ for the duration of the pulse. Once the pulse ends, an internal spring (not shown) returns the piston and the valve 26′ to the closed position, stopping the flow of colloidal mixture 12′. There is a mechanical adjustment of the stroke of the dispensing valve 26′ to adjust the flow of the colloidal mixture 12′ based on the viscosity thereof. The design of the valve 26′ eliminates dead fluid volume, allows adjustable fluid control, performs a positive shutoff without dripping sustains high volume cycles allows specified fluid input pressures and is low maintenance.

The controller 32′ is a TEACH-mode based microprocessor. The controller 32′ operates the first sensor 50 in a non-contact mode operating a specified voltage. The controller 32′ operates with a push button or remote-wire programming capability that outputs distance range compliance and part 14′ presence signals to the main automation line controller (not shown).

A fluid regulator 58 is inline between the barrel 16′ and the valve 26′. The fluid regulator 58 ensures the pressure of the colloidal mixture 12′ does not exceed a predetermined value when traveling to the valve 26′.

In the second embodiment, the supply reservoir 16′ includes two barrels 16′. The two barrels 16′ are used as a means to ensure the welding process for which the dispensing assembly 10′ supports does not have to go down while an empty barrel 16′ is replaced. A cross-over controller 60 is used to control the flow of the colloidal mixture 12′ out therefrom. When one of the two barrels 16′ empties, the cross-over controller 60 directs the flow of colloidal mixture 12′ out of the second of the two barrels 16′. A signal is then generated allowing an operator to replace the empty barrel 16′ prior to the second barrel 16′ becoming empty.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A dispensing assembly for dispensing a colloidal mixture onto a part at a weld position, said dispensing assembly comprising:
a supply reservoir for holding the colloidal mixture therein;
an inline mixer in fluid communication with said supply reservoir for mixing the colloidal mixture received from said supply reservoir;
a valve in fluid communication with said inline mixer for dispensing the colloidal mixture at the weld position; and
a preliminary mixer disposed with in said supply reservoir for preliminary mixing the colloidal mixture prior to transmission of the colloidal mixture to said inline mixture.

2. A dispensing assembly as set forth in claim 1 including a pressure reducing valve disposed between said inline mixer and said valve to reduce pressure in the colloidal mixture prior to reaching said valve.

3. A dispensing assembly as set forth in claim 2 including an inline fluid re-circulation branch for re-circulating the colloidal mixture to said supply reservoir when said valve is closed.

4. A dispensing assembly as set forth in claim 3 including a controller for opening and closing said piston valve.

5. A dispensing assembly as set forth in claim 4 including a valve recycling branch for recycling the colloidal mixture that is not dispensed through said valve.

6. A dispensing assembly as set forth in claim 5 wherein said valve is a piston valve.

7. A method for dispensing a fine colledial mixture at a weld position between first and second metal parts to absorb gases produced during the welding to reduce porosity at the weld position, the method comprising the steps of:
receiving a mixture of liquid and particles;
initially mixing the mixture of liquid and particles to create a colloidal mixture;
feeding the colloidal mixture to an inline mixture;
finely mixing the colloidal mixture to create a fine colloidal mixture;
reducing pressure applied to the fine colloidal mixture;
passing the fine colloidal mixture to a dispensing valve; and
applying the fine colloidal mixture at the weld position prior to the welding of the first and second metal parts.

8. A method as set forth in claim 7 further including the steps of re-circulating the mixture of liquid and particles when the dispensing valve is closed.

9. A method as set forth in claim 8 including the step of re-circulating the fine colloidal mixture when the dispensing valve is closed.

10. A method as set forth in claim 9 including the step of controlling the dispensing valve with compressed air.

11. A dispensing assembly for dispensing a colloidal mixture onto a part at a weld position, said dispensing assembly comprising:
a supply reservoir for holding the colloidal mixture therein;
a valve in fluid communication with said supply reservoir for dispensing the colloidal mixture at the weld position;
a controller electrically connected to said valve and operatively connected to said supply reservoir for controlling the output of the colloidal mixture from said supply reservoir;
a first sensor for locating the part and for creating a location feedback signal to identify a location of the part such that said controller can move said valve into a desired position; and
a second sensor for identifying the presence of a bead of colloidal mixture on the part and for creating a bead feedback signal to be received by said controller such that said controller controls output of the colloidal mixture at said valve to evenly apply the colloidal mixture to the part in preparation for welding.

12. A dispensing assembly as set forth in claim 11 including an air inlet to feed pressurized air into said supply reservoir to apply pressure to said colloidal mixture.

13. A dispensing assembly as set forth in claim 12 including a fluid regulator between said supply reservoir and said valve to regulate the amount of colloidal mixture transferred to said valve.

14. A dispensing assembly as set forth in claim 13 wherein said supply reservoir includes two barrels.

15. A dispensing assembly as set forth in claim 14 including a cross-over controller for selecting one of said two barrels for transmitting said colloidal mixture therefrom to said valve through said fluid regulator.
